(19) United States
(12) Patent Application Publication
(10) Pub. No.: US 2023/0191842 A1
(43) Pub. Date: Jun. 22, 2023

(54) TRUCK TIRE

(71) Applicant: The Goodyear Tire & Rubber Company, Akron, OH (US)

(72) Inventors: Ettore Passante Spaccapietra, Ettelbruck (LU); Paul Benoit Joubert, Luxembourg (LU); Roland Willibrord Krier, Wasserbillig (LU); Arun Prasath Manogaran, Everlange (LU); Anne-France Gabrielle Jeanne-Marie Cambron, Mersch (LU); Kevin Rafael Saavedra, Walferdange (LU)

(21) Appl. No.: 18/059,012

(22) Filed: Nov. 28, 2022

Related U.S. Application Data
(60) Provisional application No. 63/265,534, filed on Dec. 16, 2021.

(51) Int. Cl. B60C 9/18; B60C 9/06

(52) U.S. Cl. CPC B60C 9/185; B60C 9/06; B60C 2009/2016

(57) ABSTRACT

A pneumatic tire for use on trucks, the tire comprising: a tread which includes a belt reinforcement structure of only three belts, the belt structure including a pair of working belts, wherein the angle of the working belts range from about 10 degrees to about 50 degrees, wherein a zigzag or low angle belt is positioned preferably between the working belts or radially inward of the working belts. The belt structure further includes a rubber strip located between the radially innermost belt and the tire carcass, and preferably has a gauge that varies across the axial width of the tire.

### Field of the Invention

The invention relates in general to pneumatic tires, and more particularly for vehicles such as trucks.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability and increased load carrying capacity is desired.

### SUMMARY OF THE INVENTION

The invention provides in a pneumatic tire for use on trucks, the tire having a tread, sidewalls, and a pair of beads, and a belt reinforcement structure located radially inward of the tread, the belt structure wherein the first working belt is located radially inward of the second working belt, wherein the angle of the first and second working belts range from about 10 degrees to about 50 degrees from the circumferential direction, wherein a zigzag belt is located radially inward of the first working belt, and wherein a rubber spacer layer is located between the zigzag belt and a carcass of the tire.

### DEFINITIONS

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cable having a relative elongation at break of greater than 0.2% at 10% of the breaking load, when measured from a cord extracted from a cured tire. The tensile measurements such as the load at break (maximum load in N), strength at break (in MPa) and elongation at break (total elongation in %) are performed in tension in accordance with ISO 6892-1B (2019) at a pre-load no more than 25 MPa tested on a cable or wire when taken from a cured tire

“Inner Liner” means the layer or layers of elastomer or other material that form the inside surface of a tubeless tire and that contain the inflating fluid within the tire.

“Inserts” means the reinforcement typically used to reinforce the side edges of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Side edge” means a portion of a tire between the tread and the bead.

“Sipe” means small slots or elongated void areas typically formed by thin steel blades, and which tend to remain closed, and function to increase traction.

“Laminate structure” means an unvulcanized structure made of one or more layers of tire or elastomer components such as the innerliner, side edges, and optional ply layer.

### BRIEF DESCRIPTION OF THE DRAWINGS

The invention will be described by way of example and with reference to the accompanying drawings in which:

FIG. 1A and FIG. 1B are cross-sectional views of a first embodiment of a tire of the present invention;

FIG. 2A and FIG. 2B are cross-sectional views of a second embodiment of a tire of the present invention; and

FIG. 3 is a cross-sectional view of a third embodiment of a tire of the present invention.

### DETAILED DESCRIPTION OF THE INVENTION

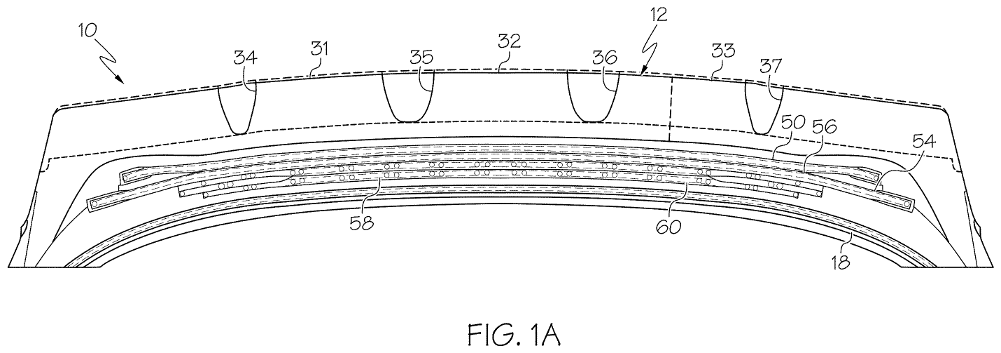

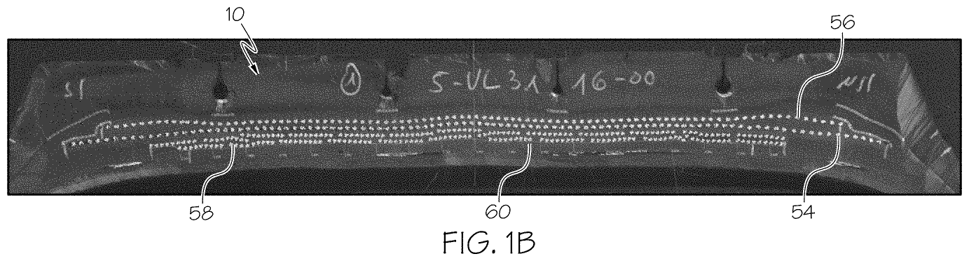

FIG. 1A and FIG. 1B illustrate a first embodiment of a pneumatic tire, suitable for use as a truck tire. The tire 10 has a tread 12 with a non-skid depth D. The tire tread 12 may comprise a plurality of circumferentially continuous ribs, which may vary, but are shown for example as ribs 31, 32 and 33. Positioned between each rib is a circumferential groove 34, 35, 36, 37 which are preferably continuous. The tread may also comprise optional sipes (not shown). The tread pattern is not limited to same, and may comprise, for example, a plurality of blocks and grooves (not shown).

The tire 10 further includes a belt package 50 which is located between the tread and the one or more plies 18. The ply 18 and the belt reinforcing structure 50 are made from cord reinforced elastomeric material, wherein the cords are typically steel wire or polyamide filaments and the elastomer preferably being rubber.

The belt reinforcing package 50 includes a pair of extensible working belts, 54, 56. Belt 54 is located radially inwards of belt 56. Belt 54 has a width which is about equal to the tread arc width. Preferably, belt 54 has a belt width substantially equal to the tread arc width. The breaker angle of belt 54 is between about 10 and 50 degrees, preferably with a right orientation.

Belt 56 is the second member of the working belt pair. Belt 56 has a width less than the width of belt 54 (the other working belt), and is preferably radially outward of belt 54. Preferably, the belt 56 has a width less than the width of belt 54 by a step off, which may range from about 10 to about 20 mm. Belt 56 has a breaker angle between about 10 and 50 degrees, preferably with a left orientation. Belt 56 has the same angle but opposite angular orientation as belt 54.

As shown in FIG. 1A and FIG. 1B, the belt structure 50 further comprises a third belt 58 which is preferably located radially inward of the working pair belts, 54, 56. The third belt is a zigzag belt reinforcing structure formed by a reinforcement strip of one or more cords, wherein the reinforcement strip is laid up in an alternating pattern from one lateral end of the tire building drum to a second lateral end of the tire building drum, wherein the reinforcement strip extends at an angle between 5° and 30° between lateral edges. The resulting zigzag belt reinforcing structure results in two layers of cord woven together. The zigzag belt 58 has an axial width less than the axial width of the working belts 56,58. The zigzag belt reinforcing structure 58 is formed of high elongation cord. The belt structure 50 further includes a rubber layer 60 located between the zigzag belt reinforcing structure and the tire carcass ply. The rubber layer 60 has an axial width the same or less than the axial width of the zigzag belt reinforcing structure 58. As shown in FIG. 1B, the rubber layer 60 preferably has a variable gauge, which ranges from 1.5 mm to 4 mm. Preferably, the maximum gauge occurs in the center of the tread and decreases to the lateral belt edge.

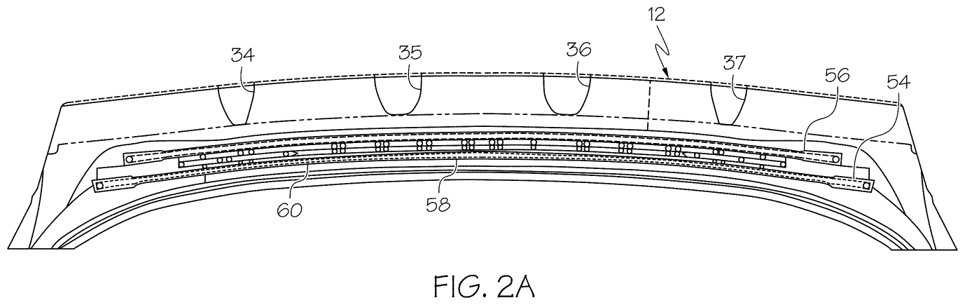

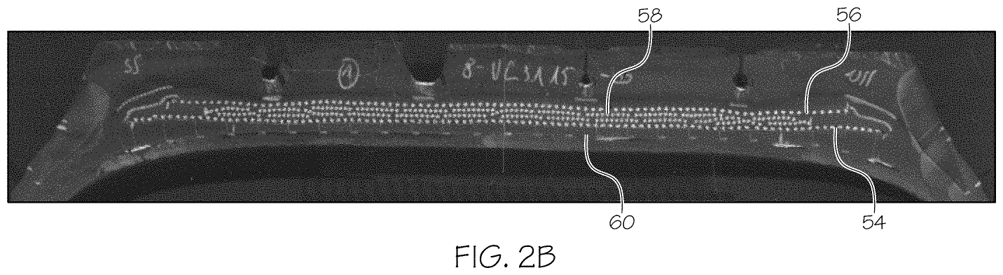

As shown in FIG. 2A and FIG. 2B, the zigzag belt 58 may be located between the working belts 54,56.

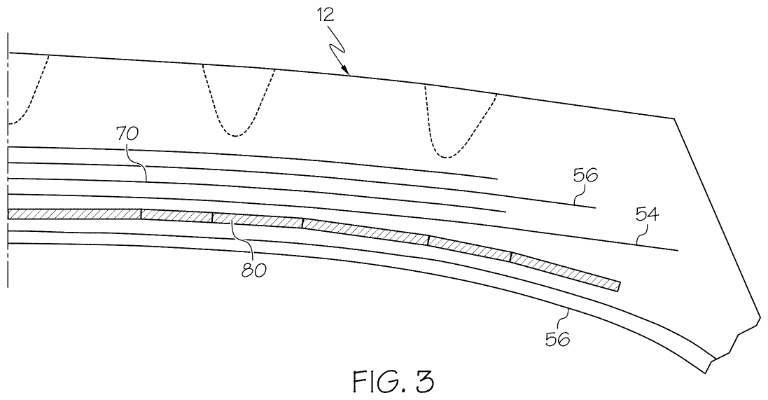

FIG. 3 illustrated a third embodiment wherein a third belt 70 is located between the working belts 54,56 and is a low angle belt 70 with reinforcements that are oriented circumferentially at 5 degrees or less, preferably 0 degrees. The low angle belt 70 is preferably formed from spirally winding a rubberized strip of two or more cords. Alternatively, the belt may be formed of a cut belt with the reinforcements oriented in the range of 0 to about 10 degrees from the circumferential direction. The low angle belt 70 has a width sized to avoid compression in the shoulder area. The belt width of the third belt 58 is preferably in the range of about 70% to about 80% of the tread arc width. The low angle belt 70 is preferably formed of high elongation cable. Cables are said to be high elongation when said cables have, under a tensile force equal to 10% of the breaking force, a relative elongation greater than 0.2% or greater than 0.8% or greater than 1.5% when taken from a cured tire. The tensile measurements such as the structural elongation (% Ats), elongation at 10% breaking load (% @ 10% BL), load at break (maximum load in N), strength at break (in MPa) and elongation at break (total elongation in %) are performed in tension in accordance with ISO 6892-1B (2019) at a pre-load no more than 10 MPa tested on a cable or wire when taken from a cured tire.

The belt package includes a rubber layer 80 located between the carcass ply and the first working belt. The rubber layer 80 has a width less than the width of the first working belt. The rubber layer 80 preferably has a variable gauge, which ranges from 1.5 mm to 4 mm. Preferably, the maximum gauge occurs in the center of the tread and decreases to the lateral belt edge.

The belt structure man include an optional overlay belt 90, which is the radially outermost belt.

The aspect ratio of the tire described above may vary. The aspect ratio is preferably in the range of about 50 to about 90. The tire may have a net to gross ratio in the range of about 70 to about 90, more preferably in the ratio of about 74 to about 86, more preferably about 78 to 84.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire for use on trucks, the tire having a tread, sidewalls, and a pair of beads, and a belt reinforcement structure located radially inward of the tread, the belt structure wherein the first working belt is located radially inward of the second working belt, wherein the angle of the first and second working belts range from about 10 degrees to about 50 degrees from the circumferential direction, wherein a zigzag belt is located radially inward of the first working belt, and wherein a rubber spacer layer is located between the zigzag belt and a carcass of the tire.

2. The tire of claim 1 wherein the width of the rubber spacer layer is equal to the axial width of the zigzag belt.

3. The tire of claim 1 wherein the width of the rubber spacer layer is less to the axial width of the zigzag belt.

4. The tire of claim 1 wherein the gauge of the rubber spacer layer varies in the axial direction.

5. The tire of claim 1 wherein the gauge of the rubber spacer layer varies in the range of 1.5 mm to 4 mm.

6. The tire of claim 1 wherein the first and second working belts are formed of extensible reinforcement cords.

7. The tire of claim 1 wherein the zigzag belt is formed of high elongation reinforcement cords.

8. The tire of claim 1 wherein the belt structure has only three belts.

9. A pneumatic tire for use on trucks, the tire having a tread, sidewalls, and a pair of beads, and a belt reinforcement structure located radially inward of the tread, the belt structure wherein the first working belt is located radially inward of the second working belt, wherein the angle of the first and second working belts range from about 10 degrees to about 50 degrees from the circumferential direction, wherein a zigzag belt is located between the first working belt and the second working belt, and wherein a rubber spacer layer is located between the first working belt and a carcass of the tire.

10. The tire of claim 9 wherein the width of the rubber spacer layer is equal to the axial width of the zigzag belt.

11. The tire of claim 9 wherein the width of the rubber spacer layer is less to the axial width of the zigzag belt.

12. The tire of claim 9 wherein the gauge of the rubber spacer layer varies in the axial direction.

13. The tire of claim 9 wherein the gauge of the rubber spacer layer varies in the range of 1.5 mm to 4 mm.

14. The tire of claim 9 wherein the first and second working belts are formed of extensible reinforcement cords.

15. The tire of claim 9 wherein the zigzag belt is formed of high elongation reinforcement cords.

16. The tire of claim 9 wherein the belt structure has only three belts.

17. A pneumatic tire for use on trucks, the tire having a tread, sidewalls, and a pair of beads, and a belt reinforcement structure located radially inward of the tread, wherein the belt reinforcement structure includes a first working belt located radially inward of a second working belt, wherein an angle of the first and second working belts range from about 10 degrees to about 50 degrees from the circumferential direction, wherein a low angle belt is located between the first working belt and the second working belt, and wherein a rubber spacer layer is located between the first working belt and a carcass of the tire.

18. The pneumatic tire of claim 17 wherein the low angle belt has reinforcements angled at less than 5 degrees.

19. The tire of claim 17 wherein the width of the rubber spacer layer is less than or equal to the axial width of the low angle belt.

20. The tire of claim 17 wherein the gauge of the rubber spacer layer varies in the axial direction.

21. The tire of claim 17 wherein the gauge of the rubber spacer layer varies in the range of 1.5 mm to 4 mm.

22. The tire of claim 17 wherein the first and second working belts are formed of extensible reinforcement cords.

23. The tire of claim 17 wherein the low angle belt is formed of high elongation reinforcement cords.
